(19) United States
(12) Patent Application Publication
(10) Pub. No.: US 2013/0127745 A1
(43) Pub. Date: May 23, 2013

(54) Method for Multiple Touch Control Virtual Objects and System thereof

(71) Applicants: Po-Tsang Li, Taichung City (TW); Yao-Sheng Yeh, Hsinchu City (TW); Ming-Hsun Chen, Taichung City (TW); Jing-Ru Chiu, Hualien County (TW); Yi-Yuan Li, Zhubei City (TW); Kuan-Chu Hou, Zhubei City (TW); Pei-Zhen Lin, New Taipei City (TW); Wei-Chien Tsai, Miaoli County (TW); Allan Lin, Taipei City (TW); Wen-Lung Tsai, New Taipei City (TW); Chung-Ming Lin, Taoyuan County (TW)

(72) Inventors: Po-Tsang Li, Taichung City (TW); Yao-Sheng Yeh, Hsinchu City (TW); Ming-Hsun Chen, Taichung City (TW); Jing-Ru Chiu, Hualien County (TW); Yi-Yuan Li, Zhubei City (TW); Kuan-Chu Hou, Zhubei City (TW); Pei-Zhen Lin, New Taipei City (TW); Wei-Chien Tsai, Miaoli County (TW); Allan Lin, Taipei City (TW); Wen-Lung Tsai, New Taipei City (TW); Chung-Ming Lin, Taoyuan County (TW)

(73) Assignee: PHIHONG TECHNOLOGY CO.,LTD., Taoyuan County (TW)

(21) Appl. No.: 13/473,994

(22) Filed: May 17, 2012

(30) Foreign Application Priority Data
Nov. 23, 2011 (TW) 100142853

(51) Int. Cl. G06F 3/041

(52) U.S. Cl. 345/173

(57) ABSTRACT

A multi-user operating system through a multi-touch panel comprises a processor; a storage medium coupled to the processor; a multiple touch panel coupled to the processor to sense multi-touch event by at least one user, followed by displaying instruction result corresponding to the multi-touch event; a display dividing module coupled to the processor to divide the multiple touch panel into at least two sub-display areas; multiple user operation module being stored in the storage medium to instruct the display dividing module to execute a multiple user mode or a single user mode, thereby allowing the multiple user manipulate virtual objects on the at least two sub-display areas, simultaneously.

### FIELD OF THE INVENTION

The present invention relates to a computer touch control system, and more particularly to a touch control presentation system and the method of the same.

### BACKGROUND OF THE INVENTION

Recently, the touch panel and technologies are widely used in consumer product. The touch-control to the virtual object within the display increases convenience. Especially, it allows the user to control the image for enlarging, shrinking and rotating the virtual object by the user finger.

In general, the presenter or the teacher employed blackboard or whiteboard to write down his points during the meeting or teaching. The listener should take note by hand writing. It is not convenience to the user at all. Currently, the computer is the typical tool during the teaching and meeting for presentation. However, the computer and the projector should be prepared before the teaching or the business presentation, and followed by projecting the information onto the screen. The one who presents the information can write none information on the screen, it is inconvenient to the user. A blackboard or whiteboard is required to fulfill the requirements for the presentation. The user needs many equipments and the setup of device is complicated and time-consuming.

Therefore, large-size electronic panel is development to replace the white board. The computer output the information onto the display of the electronic panel, which is so called the electronic whiteboard. An electronic pen is provided to allow the user to write the text onto the display, even store or print out the text and take note. Some of the electronic panels offer the function to record and display the image file.

However, there are some drawbacks to the electronic panel, for instance, the display panel size is limited, and no one can write information outside the screen. The user should erase the former information for writing further information. It is not so convenient. If the presenter or teacher requires opening several files at the same time, the user should switch among the files frequently by clicking icons. Further, the current system cannot offer dual way activities between the student and the teacher for the teaching and presentation.

What is required is a more convenient system.

### SUMMARY OF THE INVENTION

In view of the aforementioned defects of the conventional method, the present invention discloses a multiple touch presenting system and method of the same.

A method of multiple user touch control virtual objects for a computing system through a multi-touch panel comprises steps of providing a multi-touch module having a multiple user operation mode for the computing system; switching the multi-touch module to the multiple user operation mode and a display dividing module being responsive to the switching to divide a display of the multi-touch panel into at least two sub-display area. The computing system determines whether there is a touching event or not on the multi-touch panel, followed by determining whether the touching event is located on the at least two sub-display area; followed by analyzing the touching event and processing corresponding instruction based on the analyzing by the computing system.

The system further comprises a step of switching to a solo (single) user mode. The multi-touch panel can senses at least two touch events to allow a user to manipulate a virtual object. An instruction corresponding to the touch event includes content editing instruction or tool editing instruction. An application for the multiple user operation mode includes presenting software, teaching software or illustrating software.

A multi-user operating system through a multi-touch panel comprises a processor; a storage medium coupled to the processor; a multiple touch panel coupled to the processor to sense multi-touch event by at least one user, followed by displaying instruction result corresponding to the multi-touch event; a display dividing module coupled to the processor to divide the multiple touch panel into at least two sub-display areas; multiple user operation module being stored in the storage medium to instruct the display dividing module to execute a multiple user mode or a single user mode, thereby allowing the multiple user manipulate virtual objects on the at least two sub-display areas, simultaneously. The multi-touch panel can senses at least two touch events to allow the user to manipulate the virtual object. An instruction corresponding to the touch event includes content editing instruction or tool editing instruction. An application for the multiple user operation mode includes presenting software, teaching software or illustrating software.

### BRIEF DESCRIPTION OF THE DRAWINGS

The present invention may be understood by some preferred embodiments and detailed descriptions in the specification and the attached drawings below. The identical reference numbers in the drawings refer to the same components in the present invention. However, it should be appreciated that all the preferred embodiments of the invention are only for illustrating but not for limiting the scope of the Claims and wherein:

FIG. 1 is a diagram of the system according to the present invention.

FIG. 2 is an interface of the system according to the present invention.

FIG. 3A is a flow chart according to the present invention.

FIG. 3B is a flow chart according to the present invention.

### DETAILED DESCRIPTION OF THE PREFERRED EMBODIMENT

The invention will now be described with the preferred embodiments and aspects and these descriptions interpret structure and procedures of the invention only for illustrating but not for limiting the Claims of the invention. Therefore, except the preferred embodiments in the specification, the present invention may also be widely used in other embodiments.

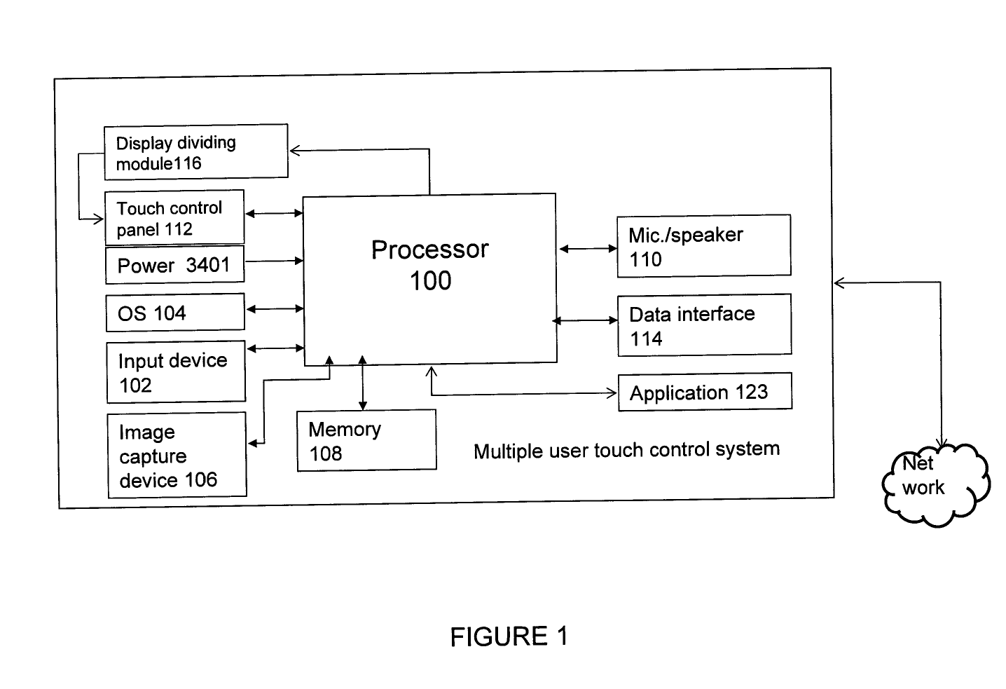

FIG. 1 shows the system of the present invention. The multi-touch control system includes processor 100 to control and process the data. An output unit 102, operation system 104, image capturing device 106 is provided to capture the image are all coupled to the processor 100. Memory or computer readable media recorder 108 is coupled to the processor 100. It may be hard drive, ROM, RAM, non-volatile memory (such as FLASH). Vocal signal is transmitted to the speaker/microphone unit 110. The system includes touch control display panel 112, and the interface 114 may allow the user to input/output information with the external device.

The output unit 102, and touch control display panel 112 are coupled to the processor. The input device 102 allows the user to input instruction to the process or 100 to execute the instruction and operate the system, and to display the interface of the OS 104 and the application 123 by the touch control display panel 112.

In one preferred embodiment, the input device 130 includes keyboard, mouse and the touch control display panel 112 includes touch control sensors. The sensing types of the touch panel include, but are not limited to, capacitor type, resist-type, IR type, SAW type. In one case, the user may utilize the touch control display panel 112 to input information directly and straight forwardly. The touch control display panel 112 may be one or multi-touch control. The user may control the virtual objects by the fingers if the panel is multi-touch control. The touch control display panel 112 may be altered by other type of display based on the requirement.

The multiple user touch control system includes the interface 114 to couple to the external device and transmit information by network. The network may be wired or wireless network, for instance, to receive the web page through mobile phone. The protocol of the mobile phone includes dual way protocol, such as GSM [symbol] CDMA [symbol] PHS [symbol] 3G [symbol] 3.5G [symbol] 4G. The communication module may receive the information offered by the service provider and be decoded and transformed into recognized signal by the mobile phone. The communication module of the device includes processor and user interface for input instruction by touching or vocal. The communication module of the device may output data in its memory for further processing such as decoding, recognition. The power 3401 is coupled to the processor 100.

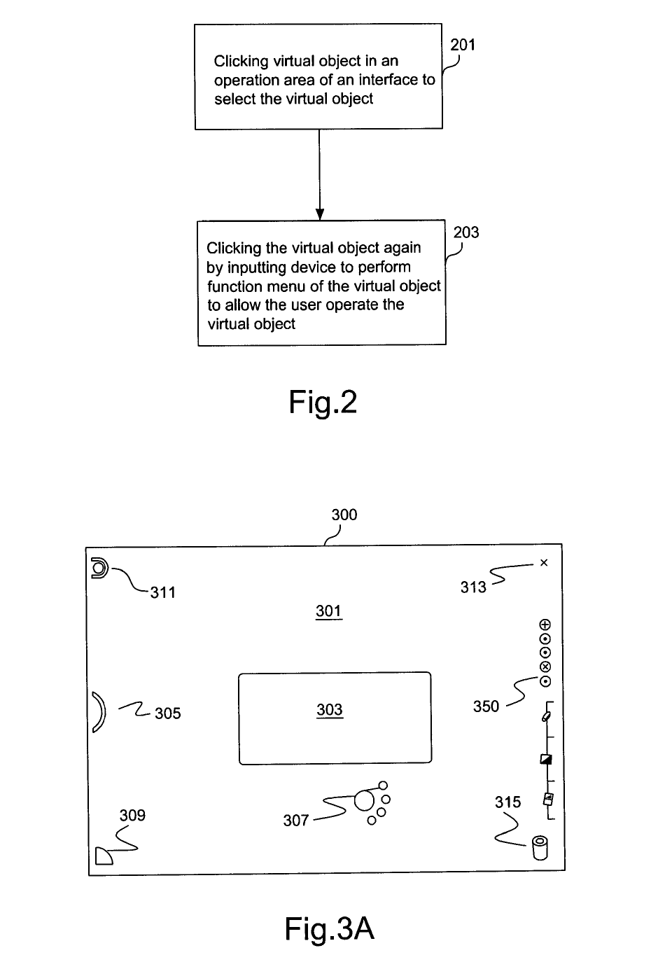

Please refer to FIG. 2, it shows the flow chart accompanying with the FIG. 1 of the present invention for manipulating the virtual object of the system. The input device 102 is coupled to the processor and the processor may recognize the action corresponding to the finger located on the touch panel. A virtual object is selected or certain instruction is performed by clicking the virtual object in the operation area of an interface generated by the system, step 201. The operation area may be defined by software and application and is displayed on the panel.

Please refer to FIG. 1, the application or program 123 is installed in the memory 108 under the environment of the OS 104, and the application may be activated or be loaded by the processor 100 to execute certain function, the corresponding interface is displayed on the screen of the touch panel. In one embodiment, the application 123 includes, but not limited to, the teaching program, illustrating program or presenting program.

The user interface of the application 123 defines at least one operation area and pluralities of instructions to allow the user may perform certain actions such as presenting, teaching, editing or illustrating in the operation area. For instance, a virtual object 303 is illustrated. More virtual objects are possible as well known in the art.

When the user manipulating the virtual object through the user interface, the processor will recognize the location signal input from the multi-touch touch panel 112 by finger touch event. In one embodiment, the multi-touch touch panel 112 allows the user to select or touch the virtual objects displayed on the panel. On the other hand, the user may click the virtual object by mouse by moving the cursor to activate the virtual objects. The keyboard may be used as well. For example, the user may press the Ctrl key on the key board and click by mouse to release the selected item. The virtual objects may be clicked by the multi-touch touch panel 112 or mouse to display the function menu for further manipulating the virtual objects in step 203.

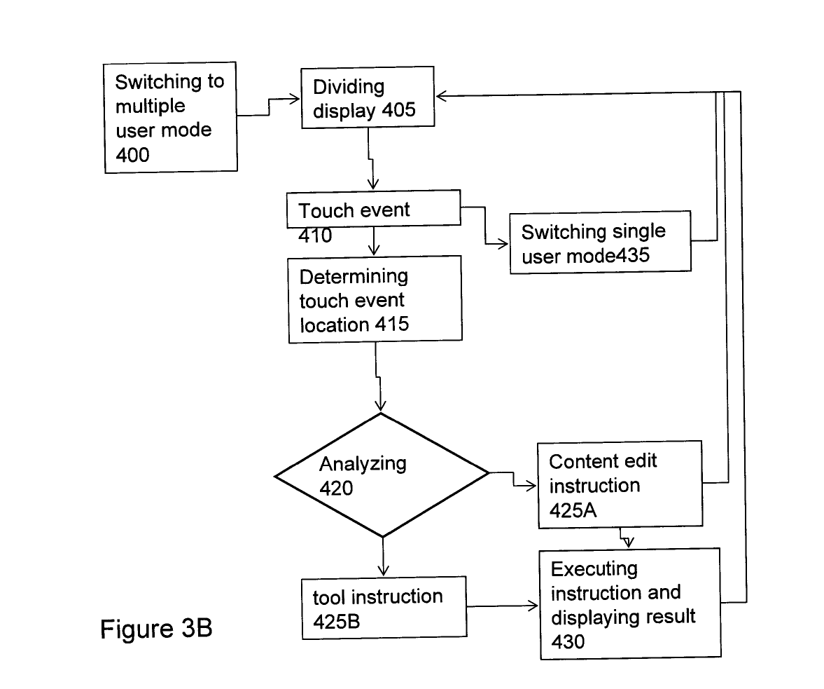

Pluralities of instructions are provided to allow the user to operate the computing system. Please refer to FIG. 3A, the function menu 305 is listed at the edges of the operation area 301 in the user interface 300. When the user triggers the function menu 305 by finger touch event or input device 130, the function menu will be displayed to show the listed function to allow the user to select desired function, for example, the image enlarge, shrinkage, or rotation etc. The input device is connected to the processor 100 and the processor may recognize the finger located on the multi-touch panel to process the pre-determined instruction input from the finger to click the virtual object in the operation area defined by the software or application on the user interface. The virtual object can be dragged and moved out of the operation area, and the processor may determine the action will be the instruction of de-activating, deleting, shrinking, enlarging, or closing the file or virtual object. Beside the function menu 305, each selected item may call an exclusive floating function menu 307 which may be floating and moving on the interface. The user may operate the virtual object depend on the requirement. It offers easier and more convenience method for the multi-user to operate the computing system through the operation area 301, simultaneously.

The operation user interface 300 may includes palette module 309 allowing the user to select the desired color for illustrating on the screen; and a status list module 311 to let the user to select the mode. In one example, the status list module 311 may be displayed all information of the list to show all of after the user clicking or touching the icon corresponding to the status list module 311. The function modes includes, not limited to, for instance, the illustrating mode, whiteboard mode, presenting mode. The user interface 300 also includes minimizing/closing window function icon 313 set in the corner of the user interface to allow the user to minimize or close the window corresponding to the application or software 123. A trash can 315 as well-known in the art is set in the user interface for deleting a selected file after dragging it into the trash can 315. The user interface 300 also includes page-label menu 350.

The user may manipulate the virtual object by the present invention to rote, shrink, and move the selected virtual object on the screen with convenience and intuition.

In order to fulfill the effects of interaction teach or presentation, the present invention may allow the multi-user to operate the virtual object simultaneously by employing display dividing module 116 to divide the display into at least two sub-displaying area for each user.

Please refer to FIG. 3B, the application 123 is a multi-user operating program for benefit to teach, illustrate and present. The application 123 will be responsive with the display dividing module 116 to transmit the corresponding instruction and user interface to the corresponding sub-display divided by the display dividing module 116, thereby allowing the user and the teacher may operate and input the instruction by independent divided sub-display. For example, the student and the teacher may select the instruction within the function list menu 305 to pull-out the selection frame in the operation area 301 and select the virtual object 303 by the selection frame having function button at the corner of the frame, and the virtual object 303 is under the status of selection. When the user touches the function button, the processor will display the function list of the selection frame to allow the user to select the further function offered by the selection frame. The application or program 123 provides more convenient and easier operation method to enhance the operating method.

In one preferred embodiment, the application 123 may support several specification or format to process and open different format file such as jpg, txt, ppt and wmv. Therefore, the user may import or load the file into the application 123 and in accompany with the processor 100 to open the files with different format for teaching or presentation. No a lot of other applications in the memory 120 is required. The user does not need to switch between different format software.

FIG. 3B illustrates the touch display panel 112 which can be divided into pluralities of sub-display areas for multi-user operation during interactive teaching or presenting. For example, one of the sub-display areas is provided for the teacher and the other is for the student. Initially, the display dividing module 116 is responsive to the application with multiple user signals (step 400) to switch to the multiple user mode to divide the display with multiple display areas in step 405. Subsequently, the processor 100 of the system is determined whether or not there is a touch event in step 410? If there is clicking event or touching event, followed by determining where is the location of the clicking event or touching event in step 415. Subsequently, if the event is found in pre-determined zone, the processor will analysis the event to determine the action or instruction, for instance, the input signal is edit instruction or tool selection such as add, delete, copy, paste, illustrate or rotation etc. The analysis will determine the instruction type is tool instruction 425B or edit instruction 425A and the instruction will be processed and the results are respectively shown on corresponding user interface in step 430. The user may switch the mode to solo mode (such as teacher mode or student mode) in step 435.

As aforementioned, the present invention provides a multi-user operation method and system to allow multi-user to operate the system and improve the efficiency of presentation or teach with interaction effects.

As indicated above, the present invention offer multiple-people operation method and virtual object manipulation method to allow the user may operating the system and virtual object more convenience and intuition to improve the effect and performance of the presentation teach. The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the invention. It is intended that all such modifications and alterations are included insofar as they come within the scope of the invention as claimed or the equivalents thereof.

What is claimed is:

1. A method of multiple user touch control virtual objects for a computing system through a multi-touch panel, comprising:
providing a multi-touch module having a multiple user operation mode for the computing system;
switching the multi-touch module to the multiple user operation mode and a display dividing module being responsive to the switching to divide a display of the multi-touch panel into at least two sub-display area;
determining by the computing system whether there is a touching event or not on the multi-touch panel, followed by determining whether the touching event is located on the at least two sub-display area;
analyzing the touching event and processing corresponding instruction based on the analyzing by the computing system.

2. The method of claim 1, further comprising switching to a solo user mode.

3. The method of claim 1, wherein the multi-touch panel can senses at least two touch events to allow a user to manipulate a virtual object.

4. The method of claim 1, wherein the instruction corresponding to the touch event includes content editing instruction or tool editing instruction.

5. The method of claim 1, wherein an application for the multiple user operation mode includes presenting software, teaching software or illustrating software.

6. A multi-user operating system through a multi-touch panel, comprising:
a processor;
a storage medium coupled to the processor;
a multiple touch panel coupled to the processor to sense multi-touch event by at least one user, followed by displaying instruction result corresponding to the multi-touch event;
a display dividing module coupled to the processor to divide the multiple touch panel into at least two sub-display areas;
multiple user operation module being stored in the storage medium to instruct the display dividing module to execute a multiple user mode or a single user mode, thereby allowing the multiple user manipulate virtual objects on the at least two sub-display areas, simultaneously.

7. The system of claim 6, wherein the multi-touch panel can senses at least two touch events to allow the user to manipulate the virtual object.

8. The system of claim 6, wherein an instruction corresponding to the touch event includes content editing instruction or tool editing instruction.

9. The system of claim 6, wherein an application for the multiple user operation mode includes presenting software, teaching software or illustrating software.

10. A multi-user operating system through a multi-touch panel, comprising:
a processor;
a storage medium coupled to the processor;
a multiple touch panel coupled to the processor to sense multi-touch event by at least one user, followed by displaying instruction result corresponding to the multi-touch event;
a display dividing module coupled to the processor to divide the multiple touch panel into at least two sub-display areas;
multiple user operation module being stored in the storage medium to instruct the display dividing module to execute a multiple user mode or a single user mode, thereby allowing the multiple user manipulate virtual objects on the at least two sub-display areas, simultaneously; wherein the multi-touch panel can senses at least two touch events to allow the user to manipulate the virtual object; an instruction corresponding to the touch event includes content editing instruction or tool editing instruction; an application for the multiple user operation mode includes presenting software, teaching software or illustrating software.
